(19) United States
(12) Patent Application Publication
(10) Pub. No.: US 2005/0121335 A1
(43) Pub. Date: Jun. 9, 2005

(54) Electropolishing apparatus, electropolishing method, and method of manufacturing semiconductor device

(75) Inventors: Takeshi Nogami, Kanagawa (JP); Naoki Komai, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/508,510

(22) PCT Filed: Mar. 14, 2003
(86) PCT No.: PCT/JP03/03112

(30) Foreign Application Priority Data
Mar. 26, 2002 (JP) 2002-085094

(51) Int. Cl. B23H 5/00

(52) U.S. Cl. 205/645

(57) ABSTRACT

The formation of a groove wiring or a via contact which causes no retreat of a metal section by overpolishing by removing a section carrying little current which locally rises in a wafer face with the progress of electropolishing. In an electropolishing apparatus comprising a counter electrode (11) at a position facing a workpiece substrate (51), the counter electrode (11) consists of concentrically disposed electrodes (11a-11e). Each of the electrodes (11a-11e) has a power supply source (13) controlled independently and comprises a detector (unillustrated) for detecting a change in the current and voltage between each of the electrodes (11a-11e) and the workpiece substrate (51) and a controller (15) for controlling a power supply to the electrodes (11a-11e) on the basis of a change in the current and voltage detected by this detector.

### TECHNICAL FIELD

The present invention relates to an electropolishing apparatus, an electropolishing method, and a method of manufacturing a semiconductor device, particularly to an electropolishing apparatus, an electropolishing method, and a method of manufacturing a semiconductor device, for electropolishing a wiring material in forming a buried wiring of a semiconductor device.

### BACKGROUND ART

Copper (Cu) wiring has been increasing in importance in fine devices in which circuit delay due to parasitic resistances and parasitic capacities of wiring become predominant, because copper wiring is lower in resistance, lower in capacity and higher in reliability than aluminum (Al) wiring. The technology which has been widely accepted as a most general method for forming a copper wiring is the groove wiring technology (for example, the Damascene technology). Among various processes of the groove wiring technology, the one which has been accepted from the viewpoint of production cost is the so-called dual Damascene process in which wiring grooves and connection holes are simultaneously formed.

However, the conventional technology has the following problems. In the conventional technology, chemical mechanical polishing (CMP) is used as a step of removing unnecessary copper present on a planar surface, leaving copper only in the grooves and holes. This step is performed by use of a polishing slurry and a consumable member such as a polishing pad. Therefore, depending on the surface conditions of the polishing pad, the CMP characteristics become unstable, and, as a result, undesired excessive polishing of copper and polishing of an insulation film which does not need polishing, such as dishing and erosion, are induced. In addition, in order to avoid such a situation, the polishing pad must be replaced frequently, leading to a lowered productivity. Besides, in a wiring technology for burying a copper wiring in a low dielectric constant insulation film, the pressure applied in CMP may deform or destruct the brittle insulation film. As a substitute for CMP for solving this problem, electropolishing has been known as a conventional technology.

The conventional electropolishing technology, however, has the following problem. Since the current necessary for electropolishing is supplied to the copper film to be polished itself, the progress of polishing is attended by local generation of portions where the current flows with difficulty, due to nonuniformity of polishing rate in the wafer plane and nonuniformity of the initial film thickness of the copper film. As a result, copper would be left in the form of islands. In addition, in order to polish the copper left in the form of islands, it is necessary to perform the electropolishing for a prolonged time, namely, to perform the so-called overpolishing. Where the overpolishing is performed for a prolonged time, however, the copper present in trenches or via holes located in the regions where the copper on the flat surface has already been removed would be polished, resulting in the generation of the so-called recesses.

### DISCLOSURE OF THE INVENTION

In order to solve the above-mentioned problems, the present invention provides an electropolishing apparatus, an electropolishing method, and a method of manufacturing a semiconductor device.

According to the present invention, there is provided an electropolishing apparatus comprising a counter electrode located at a position opposed to a work substrate, wherein the counter electrode is comprised of a plurality of electrodes disposed concentrically, and each of the electrode is provided with an electric power source designed for independent control. Also, there is provided an electropolishing apparatus as above which comprises a detector for detecting variations in current or voltage between each of the electrodes and the work substrate, and a controller for controlling the supply of electric power to each of the electrodes on the basis of the variations in current or voltage detected by the detector.

In the electropolishing apparatus as above, the counter electrode opposed to the work substrate is composed of a plurality of electrodes disposed concentrically, and each of the electrodes is provided with an electric power source designed for independent control, so that by supplying electric power to a desired electrode, the work substrate can be electropolished concentrically at a desired position. In addition, the work substrate at positions just under the electrodes not supplied with electric power is not electropolished at all or is little electropolished. Therefore, by supplying electric power to the electrodes sequentially in the order of from the electrode located at a central portion of the counter electrode toward the electrode located on the outer side of the counter electrode, the work substrate can be electropolished sequentially in the order of from a central portion thereof toward the outer side thereof. This makes it possible to polish only the portion or portions to be electropolished, while restraining excessive polishing.

In addition, the electropolishing apparatus may comprise the detector for detecting variations in current or voltage between each of the electrodes and the work substrate, and the controller for controlling the supply of electric power to each of the electrodes on the basis of the variations in current or voltage detected by the detector, so that it is possible to detect the variations in current or voltage between each of the electrodes and the work substrate and to control the supply of electric power to each of the electrodes on the basis of the variations detected, during electropolishing. This ensures that the polishing end point can be detected appropriately, and the supply of electric power to the next electrode can be performed accurately, without generating excessive polishing, so that only the portion or portions to be electropolished can be polished accurately.

According to the present invention, there is provided an electropolishing method using an electropolishing apparatus comprising an electrode located at a position opposed to a work substrate, wherein the electrode is comprised of a plurality of electrodes disposed concentrically, each of the electrodes is provided with the electric power source designed for independent control, and electropolishing is performed according a sequence of passing electric current to the electrode sequentially in the order of from smaller electrode radius to larger electrode radius. Also, there is provided an electropolishing method as above in which, during electropolishing, variations in current and voltage between each of the electrode and the work substrate are detected, and the supply of electric power to each of the electrodes is controlled based on the variations detected.

In the electropolishing method as above, the counter electrode opposed to the work substrate is composed of a plurality of electrodes disposed concentrically, and each of the electrodes is provided with the electric power source designed for independent control, so that by supplying electric power to a desired electrode, the work substrate can be electropolished concentrically at a desired position. In addition, the work substrate at positions just under the electrodes not supplied with electric power is not electropolished at all or is little electropolished. Besides, since the electropolishing is performed according to the sequence of passing electric current to the electrodes sequentially in the order of from smaller electrode radius to larger electrode radius, the work substrate can be electropolished sequentially from a central portion thereof toward the outer side thereof. This makes it possible to polish only the portion or portions to be electropolished, while restraining excessive polishing.

In addition, it may be practiced during electropolishing to detect variations in current and voltage between each of the electrodes and the work substrate and to control the supply of electric power to each of the electrodes on the basis of the variations detected, whereby it is possible to accurately detect the polishing end point and to supply electric power to the next electrode. This makes it possible to more accurately polish only the portion or portions to be electropolished, while restraining excessive polishing.

According to the present invention, there is provided a method of manufacturing a semiconductor device, comprising the step of electropolishing a metallic film formed on a substrate on which to provide a semiconductor device, by use of an electropolishing apparatus comprising an electrode located at a position opposed to the work substrate, wherein the electrode is comprised of a plurality of electrodes disposed concentrically, each of the electrodes is provided with an electric power source designed for independent control, and electropolishing is performed according to a sequence of passing electric current to the electrodes sequentially in the order of from smaller electrode radius to larger electrode radius. Also, there is provided a method of manufacturing a semiconductor device as above in which, during electropolishing, variations in current and voltage between each of the electrodes and the metallic film are detected, and the supply of electric power to each of the electrodes is controlled based on the variations detected.

In the method of manufacturing a semiconductor device as above, like in the above-mentioned electropolhsing method, it is possible to polish only the portion or portions to be electropolished, while restraining excessive polishing. Therefore, in the case of, for example, removing only a surplus metallic film present on a substrate after burying a metal in trenches and via holes and forming the metallic film on the substrate, the surplus metallic film on the substrate can only be electropolished, without removing the metal present in the trenches and via holes. Therefore, it is possible to form trench wirings and via hole contacts with high reliability.

### BRIEF DESCRIPTION OF DRAWINGS

FIG. 1 is a schematic plan view showing one embodiment of the electropolishing apparatus according to the present invention.

FIG. 2 is a schematic sectional view showing the positional relationship between a counter electrode and a work substrate.

FIGS. 3A and 3B are schematic sectional views showing another configuration of the counter electrode 11.

FIGS. 4A and 4B are schematic sectional views for illustrating the electropolishing method according to the present invention.

### BEST MODE FOR CARRYING OUT THE INVENTION

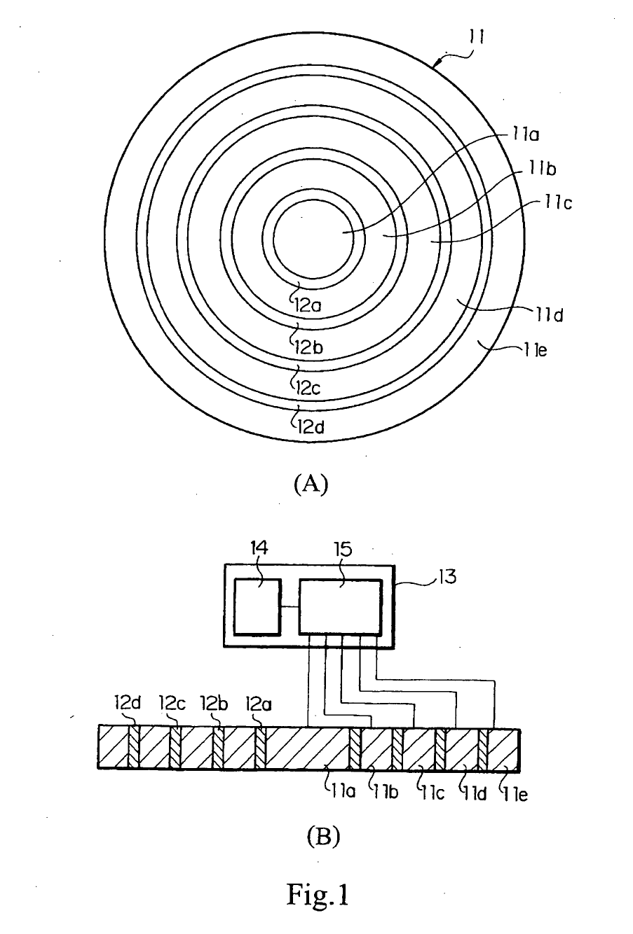

One embodiment of the electropolishing apparatus according to the present invention will be described referring to FIG. 1. In FIG. 1, (A) shows a plan view of a counter electrode, and (B) shows general configuration of the counter electrode and an electric power source which constitute an essential part of the present invention. Incidentally, in FIG. 1(B), the counter electrode is shown in section.

The electropolishing apparatus according to the present invention is a known electropolishing apparatus comprising an electrode at a position opposed to a work substrate, which is characterized by the structure of the electrode and the supply of electric power. Therefore, the electrode and the electric power supply will be described in detail below.

As shown in FIG. 1, the counter electrode 11 is composed of a plurality of electrodes 11a, 11b, 11c, 11d, and 11e disposed concentrically. While five electrodes 11a to 11e (a circular disk-like electrode 11a, and annular electrodes 11b, 11c, 11d, and 11e) are shown here, the number of the electrodes is not limited to five but may be two or more; as the number of the electrodes is greater, more precise electropolishing can be achieved. In addition, annular insulators 12a, 12b, 12c, and 12d are provided between the electrodes, namely, between the electrodes 11a and 11b, between the electrodes 11b and 11c, between the electrodes 11c and 11d, and between the electrodes 11d and 11e. The width of the insulators 12 is preferably as small as possible within such a range as to promise insulation between the electrodes, in order to obviate nonuniformity of polishing.

Further, an electric power source 13 designed for supply of independently controlled electric power is connected to each of the electrodes 11a to 11e.

The electric power source 13 is composed, for example, of a power source 14, and a controller 15 for supplying electric power from the power source 14 to each of the electrodes 11a to 11e under control. It suffices that the electric power source 13 can supply independently controlled electric power to each of the electrodes 11a to 11e.

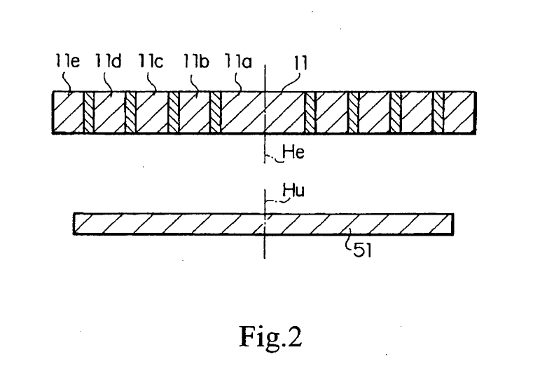

As shown in FIG. 2, the counter electrode 11 is disposed at such a position that the center thereof is opposed to the center of a work substrate 51; that is, the counter electrode 11 is disposed so that the vertical line He passing through the center of the counter electrode 11 coincides with the vertical line Hu passing through the center of the work substrate (e.g., wafer).

Further, a detector (not shown) for detecting variations in current and voltage is provided between each of the electrodes 11a to 11e and the work substrate 51. Based on the variations in current or voltage detected by the detector, the supply of electric power to each of the electrodes 11a to 11e is controlled by the controller 15 (see FIG. 1).

In the electropolishing apparatus comprising the counter electrode 11, the electric power source 13 and the like, the counter electrode 11 is composed of the plurality of electrodes 11a to 11e disposed concentrically, and each of the electrodes 11a to 11e is provided with the electric power source 13 designed for independent control, so that electric power can be supplied to a desired electrode (for example, the electrode 11a), whereby the work substrate 51 at the position just under the electrode supplied with electric power (for example, the electrode 11a) can be electropolished. On the other hand, the work substrate at positions just under the electrodes not supplied with electric power (for example, the electrodes 11b to 11e) is not electropolished at all or is little electropolished. Therefore, by supplying electric power sequentially in the order of from the electrode 11a at a central portion of the counter electrode 11 toward the electrode 11e on the outer side of the counter electrode 11, the work substrate 51 can be electropolished sequentially in the order of from the central portion of the work substrate 51 toward the outer side of the work substrate 51. This makes it possible to polish only the portion or portions to be electropolished, while restraining excessive polishing.

In addition, there are provided the detector (not shown) for detecting variations in current or voltage between each of the electrodes 11a to 11e and the work substrate 51, and the controller 15 for controlling the supply of electric power to each of the electrodes 11a to 11e on the basis of the variations in current or voltage detected by the detector. Therefore, it is possible, during electropolishing, to detect the variations in current and voltage between each of the electrodes 11a to 11e and the work substrate 51 and to control the supply of electric power to each of the electrodes 11a to 11e on the basis of the variations detected. This ensures that the end point of polishing is appropriately detected in polishing relevant to each of the electrodes 11a to 11e, and the supply of electric power to the next electrode can be accurately performed without generating excessive polishing, so that only the portion or portions to be electropolished can be polished accurately.

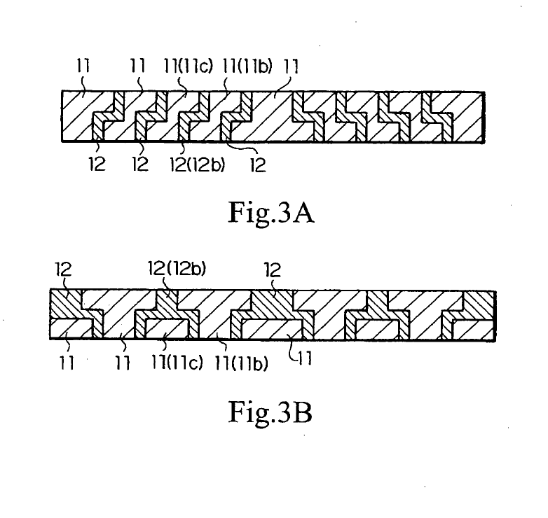

Next, another example of configuration of the counter electrode 11 will be described referring to schematic sectional views shown in FIGS. 3A and 3B.

As shown in FIG. 3A, a plurality of (e.g., in the figure, five) counter electrodes 11 are disposed concentrically, with the insulators 12 therebetween. Of each adjacent pair of electrodes, one electrode (e.g., the electrode 11c) is formed in the state of overlapping the other electrode (e.g., the electrode 11b), with the insulator (e.g., the insulator 12b) therebetween. Also, as shown in FIG. 3B, a plurality of (e.g., in the figure, five) counter electrodes 11 are disposed concentrically, with the insulators 12 therebetween. Of each adjacent pair of electrodes, one electrode (e.g., the electrode 11b) is formed in the state of overlapping the other electrode (e.g., the electrode 11c), with the insulator (e.g., the insulator 12b) therebetween. With the electrode structures shown in FIGS. 3A and 3B, nonuniformity of polishing due to the width of the insulator between the electrodes can be restrained from being generated.

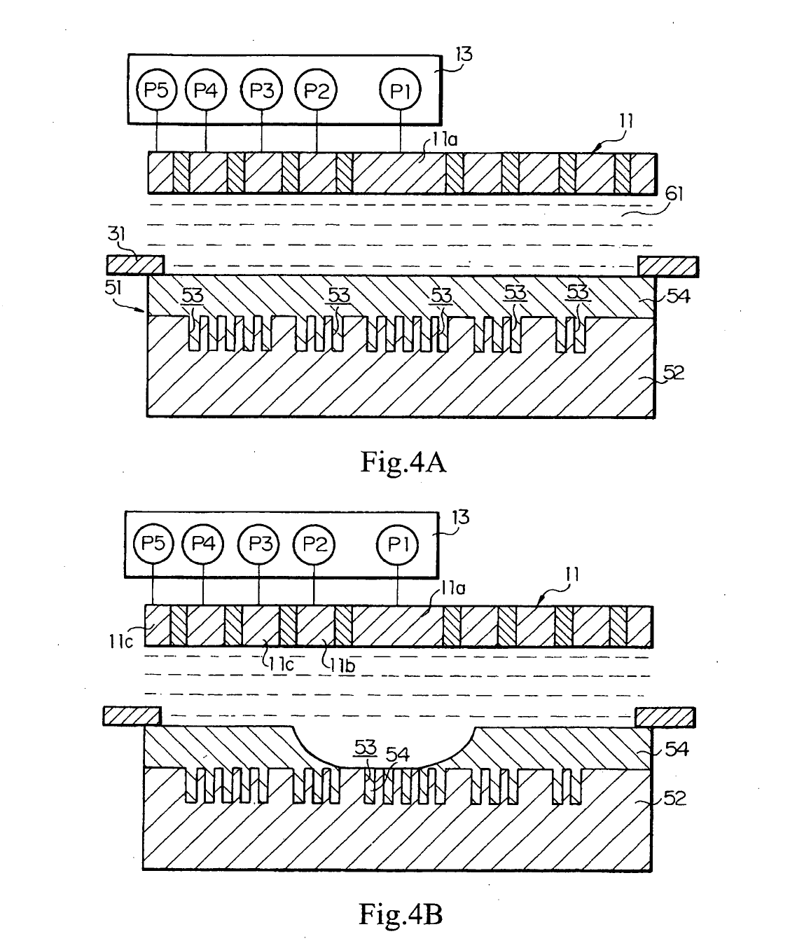

Next, the electropolishing method according to the present invention by use of the electropolishing apparatus comprising the counter electrode 11 will be described referring to FIGS. 4A and 4B.

As shown in FIG. 4A, a work substrate 51 is prepared, in which a substrate 52 is provided with trenches (inclusive of via holes) 53, and a copper film 54 for filling the trenches 53 is formed on the substrate 52. An anode 31 is connected to an outer circumferential portion of the copper film 54 of the work substrate 51. The anode 31 is formed, for example, in an annular form, and is connected to the outer circumference of the copper film 54 at the entire part of the annular portion thereof. In addition, supply of electric power is conducted with the counter electrode 11 as cathode. Besides, the gap between the work substrate 51 and the counter electrode 11 is filled with an electrolytic solution 61.

First, a voltage is applied from an electric power source 13 (P1) to an electrode 11a located at a central portion of the counter electrode 11, whereupon an electric current flows between the electrode 11a and the anode 31 through the copper film 54 and the electrolytic solution 61. As a result, the copper film 54 at a central portion of the work substrate 51 just under the electrode 11a where current density is concentrated is electropolished and lost, preferentially over the copper film 54 located at other portions.

As a result, as shown in FIG. 4B, copper on the surface of the central portion of the substrate 52 disappears, leaving the copper film 54 in the trenches (via holes) 53 located at that portion. In this instance, at a detector (not shown) for monitoring the resistance connected to the electrode 11a, an increase in electric resistance due to the disappearance of the copper film 54 at the central portion of the work substrate 51 is detected.

In response to the signal of the increase in resistance, electric power is supplied from an electric power source 13 (P2) to an electrode 11b which is the nearest to the electrode 11a and is larger in diameter than the electrode 11a. Namely, flow of the current is started. Simultaneously, the supply of electric power from the electric power source 13 (P1) to the electrode 11a is stopped or reduced. If the supply of electric power to the electrode 11a is not stopped or reduced, the electropolishing at that portion would proceed, leading to the disappearance of copper in the trenches 53. Therefore, it is necessary to stop or reduce the supply of electric power to the electrode 11a.

Upon the changeover of electric power supply, no current or a faint current only will flow in the central portion of the substrate 52, because the resistance is raised due to the disappearance of the copper film 54 on the surface of the central portion of the substrate 52 or because of the intentional stoppage or reduction of the supply of electric power from the electrode 11a at the central portion of the counter electrode 11. As a result, copper in the trenches (via holes) 53 located at the central portion of the substrate 52 where copper on the flat surface of the substrate 52 has already disappeared is not electropolished, and, accordingly, generation of excessive recesses is obviated.

Simultaneously, the portion of the copper film located just under the electrode 11b located at a position slightly deviated from the center of the substrate 52 toward the outer circumference of the substrate 52, namely, just under the electrode 11b currently supplied with electric power, is electopolished preferentially over the other portions of the copper film. As a result, the copper film on the flat surface of the substrate 52 at the position just under the electrode 11b and in the vicinity thereof disappears; then, in the same manner as in the control corresponding to the change in resistance at the electrode 11a, electric power is supplied from an electric power source 13 (P3) to an electrode 11c which is the nearest to the electrode 11b and is larger in diameter than the electrode 11b. Simultaneously, the supply of electric power from the electric power source 13 (P2) to the electrode 11b is stopped or reduced.

This sequence is repeated sequentially in the order of from the central portion side of the substrate 52 toward the electrode 11e at the outer circumferential portion of the substrate 52, and, finally, electropolishing of the copper film 54 located up to an edge portion of the substrate 52 is finished.

In the electropolishing method described above, the counter electrode 11 opposed to the work substrate 51 is composed of the plurality of electrodes 11a to 11e disposed concentrically, and each of the electrodes 11a to 11e is provided with the electric power source 13 (P1 to P5) designed for independent control, so that by supplying electric power to a desired electrode (for example, the electrode 11a), the work substrate 51 can be electropolished concentrically at a desired position. In addition, the work substrate 51 at positions just under the electrodes not supplied with electric power (for example, the electrodes 11b to 11e) is not electropolished at all or is little electropolished. Since the electropolishing is performed according to the sequence of supplying electric power (for example, passing an electric current) to the electrodes sequentially in the order of from smaller electrode radius to larger electrode radius, the work substrate 51 can be electropolished sequentially in the order of from a central portion thereof toward the outer side thereof. This makes it possible to polish only the portion or portions to be electropolished, while restraining excessive polishing.

Incidentally, the work substrate 51 is electropolished sequentially in the order of from the central portion thereof toward the outer circumferential side thereof, because the anode 31 is connected to the outer circumferential side of the work substrate 51. If the anode 31 is connected to the central portion of the work substrate 51, the electropolishing is performed in the order of from the outer circumferential side of the work substrate 51 toward the central portion of the work substrate 51.

In addition, since the variations in current and voltage between each of the electrodes 11b to 11e and the work substrate 51 are detected and the supply of electric power to each of the electrode 11b to 11e is controlled based on the variations detected, it is possible to appropriately detect the end point of polishing and to supply electric power to the next electrode. This makes it possible to more accurately polish only the portion or portions to be electropolished, while restraining excessive polishing.

Incidentally, the timings of starting, reducing and stopping the supply of electric power to each of the electrodes 11a to 11e are not limited to the form in the embodiment described above; an adjustment for optimization is conducted so as to prevent excessive recesses from being generated in the copper present in the trenches and via holes, while entirely removing the copper present on the flat surface of the substrate 52. For example, it is possible to introduce a step of thinning the copper film on the flat surface of the substrate over the whole area of the substrate at a stroke by passing electric current to all the electrodes disposed concentrically.

In addition, by use of the electropolishing method as above, uniform etching and electropolishing free of recess formation can be achieved even in the case where the initial copper film before electropolishing has a concentric film thickness distribution, while preventing copper from being left in the area of a larger initial film thickness under the influence of the initial film thickness distribution.

The electropolishing method according to the present invention, by which the surplus copper film on the surface of the substrate 52 can be removed while leaving copper in the inside of trenches and via holes as above-described, can be applied to the formation of trench wirings and via contact plugs formed in an insulation film on a semiconductor substrate.

When the electropolishing method of the present invention is thus applied to a method of manufacturing a semiconductor device, it is possible, like in the electropolishing method above, to polish only the portion or portions to be electropolished, while restraining excessive polishing. Therefore, in the case of, for example, removing only the surplus metallic film on the substrate after filling trenches and via holes with a metal and forming the metallic film on the substrate, the surplus metallic film on the substrate can only be electropolished without removing the metal present in the trenches and via holes. Therefore, it is possible to form trench wirings and via hole contacts with high reliability.

Besides, the structure of the counter electrode 11 in the electropolishing apparatus according to the present invention can be used, for example, for a counter electrode in an electrolytic etching apparatus. Also, the structure can be used, for example, for a counter electrode in an electroplating apparatus.

Industrial Applicability

As has been described above, according to the electropolishing apparatus of the present invention, electric power can be supplied from the electric power sources designed for independent control to the plurality of electrodes disposed concentrically, so that a work substrate can be electropolsihed concentrically at a desired position while ensuring that the work substrate at positions just under the electrodes not supplied with electric power is not electropolished at all or is little electropolished. This makes it possible to polish only the portion or portions to be electropolished, while restraining excessive polishing. In addition, since there are provided the detectors for detecting variations in current or voltage between each of the electrodes and the work substrate, and the controller for controlling the supply of electric power to each of the electrodes, it is possible to appropriately detect the end point of polishing, to accurately supply electric power to the next electrode, without generating excessive polishing, and to accurately polish only the portion or portions to be electropolished.

According to the electropolishing method of the present invention, since electric power can be supplied from the electric power sources designed for independent control to the plurality of electrodes disposed concentrically, a work substrate can be electropolished concentrically at a desired position while ensuring that the work substrate at positions just under the electrodes not supplied with electric power is not electropolished at all or is little electropolished. Also, since the electropolishing is performed according to the sequence of passing electric current to the electrodes sequentially in the order of from smaller electrode radius to larger electrode radius, the work substrate can be electropolished in the order of from a central portion thereof toward the outer side thereof, while restraining excessive polishing. In addition, during the electropolishing, variations in current and voltage between each of the electrodes and the work substrate are detected, and the supply of electric power to each of the electrodes is controlled based on the variations detected, so that it is possible to appropriately detect the end point of polishing, to supply electric power to the next electrode, and more accurately polish only the portion or portions to be electropolished, while restraining excessive polishing.

According to the method of manufacturing a semiconductor device of the present invention, like in the above electropolishing method, only the portion or portions to be electropolished can be polished while restraining excessive polishing. Therefore, in the case of, for example, removing only a surplus metallic film on a substrate after filling trenches and via holes with a metal and forming the metallic film on the substrate, the surplus metallic film on the substrate can only be electropolished without removing the metal present in the trenches and via holes. Therefore, it is possible to form trench wirings and via hole contacts with high reliability, so that it is possible to manufacture a semiconductor device with high reliability.

1. An electropolishing apparatus comprising a counter electrode at a position opposed to a work substrate, wherein
said counter electrode is comprised of a plurality of electrodes disposed concentrically, and
each of said electrodes is provided with an electric power source designed for independent control.

2. An electropolishing apparatus as set forth in claim 1, comprising:
a detector for detecting variations in current and voltage between each said electrode and said work substrate, and
a controller for controlling the supply of electric power to each said electrode, based on the variations in current and voltage detected by said detector.

3. An electropolishing method using an electropolishing apparatus comprising a counter electrode at a position opposed to a work substrate, wherein
said counter electrode is comprised of a plurality of electrodes disposed concentrically,
each of said electrodes is provided with an electric power source designed for independent control, and
electropolishing is performed according to a sequence for supplying electric power to said electrodes sequentially in the order of from smaller electrode radius to larger electrode radius.

4. An electropolishing method as set forth in claim 3, comprising the steps of:
detecting the variations in current or voltage between each said electrode and said work substrate, and controlling the supply of electric power to each said electrode on the basis of the variations detected, during electropolishing.

5. A method of manufacturing a semiconductor device, comprising the step of electropolishing a metallic film formed on a substrate on which to provide a semiconductor device, by use of an electropolishing apparatus comprising a counter electrode at a position opposed to the work substrate, wherein
said counter electrode is comprised of a plurality of electrodes disposed concentrically,
each of said electrodes is provided with an electric power source designed for independent control, and
the electropolishing is performed according to a sequence for supplying electric power to said electrodes sequentially in the order of from smaller electrode radius to larger electrode radius.

6. A method of manufacturing a semiconductor device as set forth in claim 5, comprising the steps of:
detecting variations in current or voltage between each said electrode and said metallic film, and controlling the supply of electric power to each said electrode on the basis of the variations detected, during the electropolishing.
